(19) United States
(12) Patent Application Publication
(10) Pub. No.: US 2016/0048649 A1
(43) Pub. Date: Feb. 18, 2016

(54) DISEASE PREDICTING APPARATUS AND DISEASE PREDICTING METHOD

(71) Applicant: NIHON KOHDEN CORPORATION, Tokyo (JP)

(72) Inventor: Norihito KONNO, Tokyo (JP)

(73) Assignee: NIHON KOHDEN CORPORATION, Tokyo (JP)

(21) Appl. No.: 14/816,459

(22) Filed: Aug. 3, 2015

(30) Foreign Application Priority Data
Aug. 13, 2014 (JP) 2014-164703

(51) Int. Cl. G06F 19/00; G06N 7/00

(52) U.S. Cl. CPC G06F 19/345; G06N 7/005

(57) ABSTRACT

A disease predicting apparatus and a disease predicting method are provided. The disease predicting apparatus includes a first parameter acquiring unit configured to acquire a first parameter indicating a biological condition of a subject, a second parameter acquiring unit configured to acquire a second parameter indicating another biological condition of the subject or the like, a statistical value calculating unit configured to calculate a statistical value indicating relationships between the first parameter and the second parameter, a storage unit storing definition information that defines a sign of a disease by the relationships between the first parameter and the second parameter, and an analyzing unit configured to analyze a sign of a disease of the subject based on a temporal change of the statistical value and the definition information.

### CROSS-REFERENCE TO RELATED APPLICATION(S)

The present application claims priority from Japanese Patent Application No. 2014-164703 filed on Aug. 13, 2014, the entire content of which is incorporated herein by reference.

### BACKGROUND

The presently disclosed subject matter relates to a disease predicting apparatus, a disease predicting method, and a program.

Recently, an aging society is becoming a serious problem worldwide. Particularly in Japan, the problem of aging is quite significant. It is said that the social security in Japan will be shifted from a structure in which one aged person is supported by three or four persons of productive age, to a structure in which one aged person is supported by one person of productive age. In such a social structure, it is necessary to consider particularly the following points.

Firstly, when the percentage of aged persons is increased, there is a possibility that medical expenses are remarkably increased. Therefore, it is important to promptly treat a patient of disease and soon discharge the patient from hospital. Secondly, from the viewpoint of utilization of aged persons, it is important not to put an aged person in hospital (preventing an aged person from getting sick). As a countermeasure against the two points, it is critical to immediately assess the risk of disease before the disease becomes worse.

The recent improvement in processing power of a computer enables a large volume of data in a wide variety of formats to be handled at high velocities. Under this circumstance, various analyzing methods and techniques such as machine learning and data mining are used in various fields. Also in the medical field, studies are being made to use these techniques in disease prediction and the like.

A related art for predicting the risk of a disease by using statistical analysis or the like will be described. According to a first related art, an apparatus is configured to compare saliva data acquired from a subject with previously stored correlation data, to determine a lifestyle disease (see, e.g., JP2014-130096A). According to a second related art, a correlation between a body weight of a subject and medical examination data (total cholesterol and the like) is analyzed, and health condition is estimated from the result of the analysis (see, e.g., JP2009-181564A).

According to the first related art, the risk of a lifestyle disease at the time of the acquisition of the saliva data is determined by comparing the saliva data with the correlation data. According to the second related art, the health condition at the time of the medical examination is determined based on the body weight. That is, in both cases, the risk of a disease or the health condition at a certain point of time is analyzed based on relationships (correlation) of a plurality of biological parameters. In other words, a future risk of a disease or the like cannot be predicted in advance. Some biological information monitors can predict future from a variation of a biological parameter (e.g., can catch a heart abnormality when heart rate is rapidly decreasing), but cannot predict a disease related to a plurality of parameters.

Therefore, there is a need to establish a technique for predicting an occurrence of a disease related to a plurality of parameters. Here, the “parameters” may include not only biological parameters (e.g., blood pressure, respiratory rate, body temperature, pulse wave, heart rate) but also environmental factors (e.g., temperature, humidity, illuminance, noise), and/or attributes of a subject (e.g., sex, age, residence) and the like.

### SUMMARY

Illustrative aspects of the present invention provide a disease predicting apparatus, disease predicting method, and program which can predict a disease related to a plurality of parameters.

According to an illustrative aspect of the present invention, a disease predicting apparatus is provided. The disease predicting apparatus includes a first parameter acquiring unit configured to acquire a first parameter indicating a biological condition of a subject, a second parameter acquiring unit configured to acquire a second parameter indicating another biological condition of the subject, a statistical value calculating unit configured to calculate a statistical value indicating relationships between the first parameter and the second parameter, a storage unit storing definition information that defines a sign of a disease by the relationships between the first parameter and the second parameter, and an analyzing unit configured to analyze a sign of a disease of the subject based on a temporal change of the statistical value and the definition information.

According to another illustrative aspect of the present invention, a disease predicting apparatus is provided. The disease predicting apparatus includes a first parameter acquiring unit configured to acquire a first parameter indicating a biological condition of a subject, a second parameter acquiring unit configured to acquire a second parameter relating to a factor of an environment surrounding the subject or an attribute of the subject, a statistical value calculating unit configured to calculate a statistical value indicating relationships between the first parameter and the second parameter, a storage unit storing definition information that defines a sign of a disease by the relationships between the first parameter and the second parameter, and an analyzing unit configured to analyze a sign of a disease of the subject based on a temporal change of the statistical value and the definition information.

According to another illustrative aspect of the present invention, a disease predicting method includes steps of acquiring a first parameter indicating a biological condition of a subject, acquiring a second parameter indicating another biological condition of the subject, calculating a statistical value indicating relationships between the first parameter and the second parameter, and analyzing a sign of a disease of the subject based on temporal change of the statistical value and definition information that defines the sign of the disease by the relationships between the first parameter and the second parameter.

According to another illustrative aspect of the present invention, a non-transitory computer readable medium stores a program that, when executed by a computer, causes the computer to execute a method including steps of calculating a statistical value indicating relationships between a first parameter indicating a biological condition of a subject and a second parameter indicating another biological condition of the subject, and analyzing a sign of a disease of the subject based on a temporal change of the statistical value and definition information that defines the sign of the disease by relationships between the first parameter and the second parameter.

The definition information defines a sign of a disease by the relationships between the biological parameters. The analyzing unit performs the analysis by using a change of the statistical value calculated from the first parameter and the second parameter. A change of the statistical value is an effective index indicating a change of the biological condition of the subject. The analyzing unit compares the change of the statistical value with the definition information, whereby a possibility of a future occurrence of a disease in the subject can be predicted.

### BRIEF DESCRIPTION OF DRAWINGS

FIG. 1 is a block diagram illustrating a configuration of a disease predicting apparatus according to an exemplary embodiment of the present invention;

FIG. 2 is a scatter diagram showing an example of relationships between a heart rate (HR) and a pulse rate (PR);

FIGS. 3A and 3B illustrate examples of definition information;

FIG. 4 is a diagram illustrating an example of relationships between a change of a slope obtained from the heart rate (HR) and the pulse rate (PR) and a sign of a disease; and

FIG. 5 is a scatter diagram showing an example of relationships between the heart rate (HR) and a respiration rate (RR).

### DETAILED DESCRIPTION

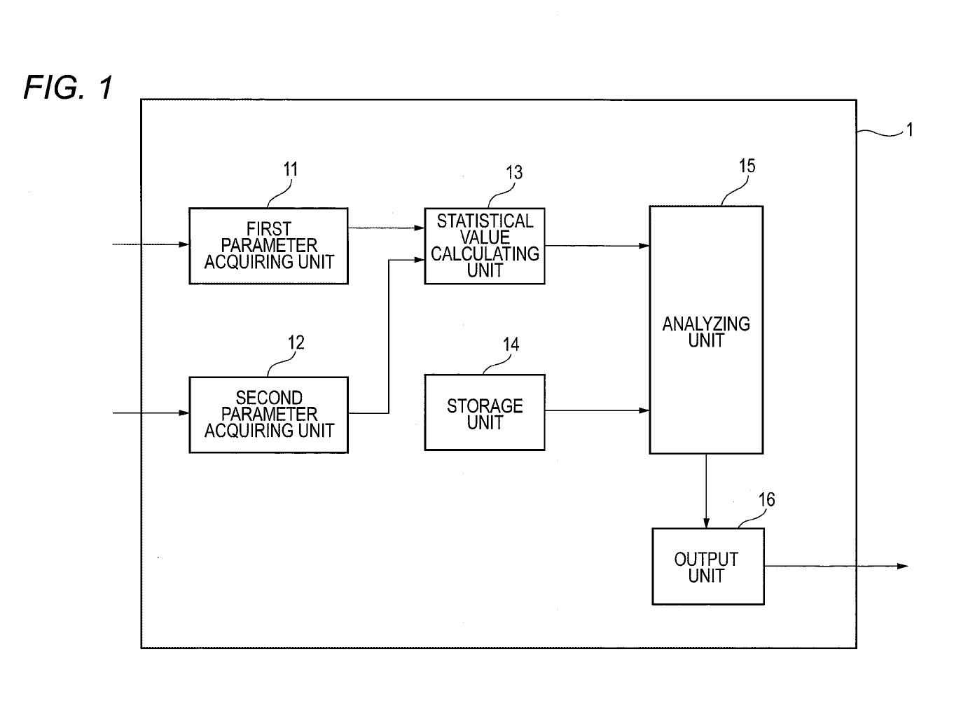

Hereinafter, an exemplary embodiment of the invention will be described with reference to the drawings. FIG. 1 is a block diagram illustrating a configuration of a disease predicting apparatus 1. The disease predicting apparatus 1 is, for example, a medical apparatus, such as a biological information monitor, configured to acquire a plurality of biological parameters.

The disease predicting apparatus 1 includes a first parameter acquiring unit 11, a second parameter acquiring unit 12, a statistical value calculating unit 13, a storage unit 14, an analyzing unit 15, and an output unit 16.

The first parameter acquiring unit 11 acquires various biological parameters from the body of the subject. The first parameter acquiring unit 11 is connected to, for example, electrodes (not shown) which are attached to the body of the subject, and detects biological signals from the electrodes, thereby acquiring biological parameters. The first parameter acquiring unit 11 supplies the acquired values to the statistical value calculating unit 13. For example, the biological parameters which are acquired by the first parameter acquiring unit 11 are a respiration rate (RR), an ECG, a pulse rate (PR), a heart rate (HR), and the like.

The second parameter acquiring unit 12 acquires various biological parameters from the body of the subject, similarly with the first parameter acquiring unit 11. The second parameter acquiring unit 12 acquires biological parameters which are different from those acquired by the first parameter acquiring unit 11, and supplies the acquired values to the statistical value calculating unit 13.

In the following description, the biological parameters acquired by the first parameter acquiring unit 11 are referred to as the first parameter, and those acquired by the second parameter acquiring unit 12 are referred to as the second parameter.

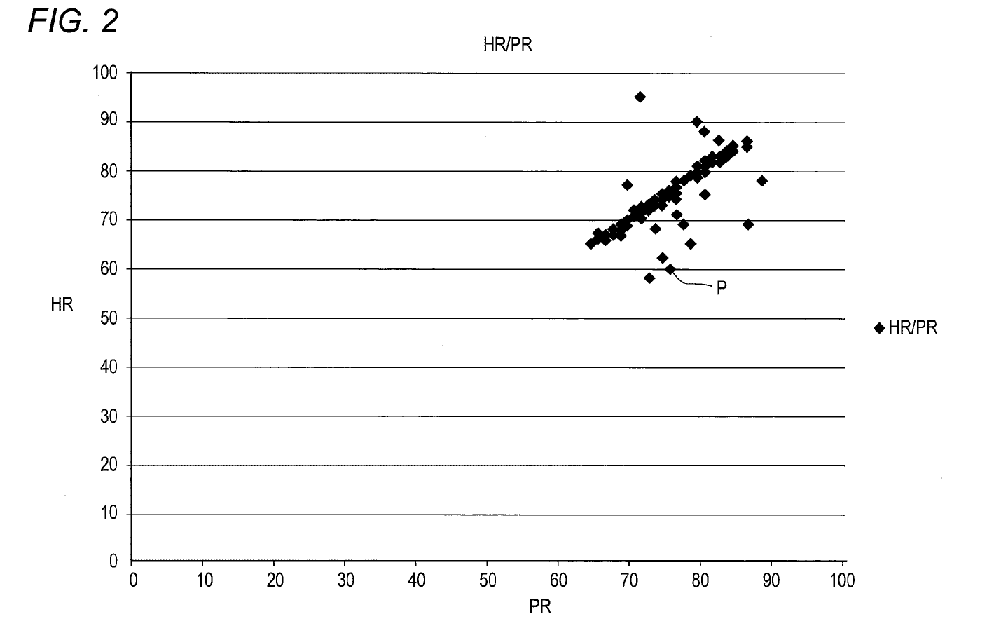

The statistical value calculating unit 13 calculates a statistical value based on the acquired value of the first parameter acquiring unit 11, and that of the second parameter acquiring unit 12. For example, the statistical value includes the correlation coefficient, the standard deviation (SD), the slope of an approximate expression obtained from a coordinate system on which the acquired values of the both parameters are plotted, and the like. Referring to FIG. 2, the meaning of the statistical value will be described in detail. In FIG. 2, it is assumed that the first parameter is the heart rate (HR), and the second parameter is the pulse rate (PR).

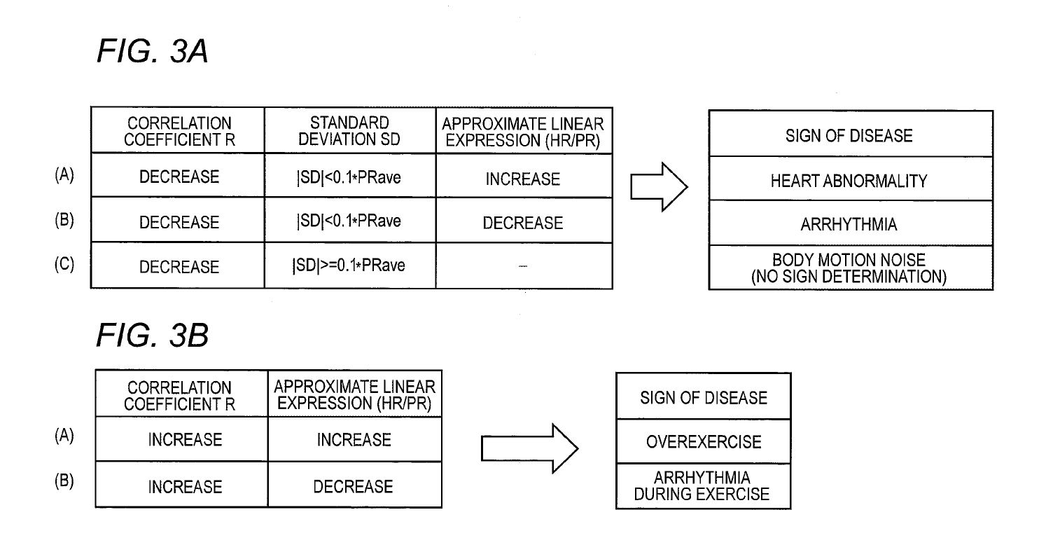

As shown in FIG. 2, a coordinate system of a set of the heart rate (HR) and the pulse rate (PR) at each point of time is defined. In FIG. 2, for example, the point P indicates that the heart rate (HR) is 60 and the pulse rate (PR) is 76 at a certain point of time. The statistical value calculating unit 13 periodically calculates the correlation coefficient, the standard deviation, or the slope of an approximate expression (HR/PR). In accordance with the analysis contents of the analyzing unit 15, the statistical value calculating unit 13 switches the kind of the statistical value to be calculated. If the standard deviation exceeds a reference, for example, the statistical value calculating unit 13 determines that noise occurs, and the process is ended (this will be described with reference to (C) of FIG. 3A). If not, the statistical value calculating unit 13 calculates also the slope of the approximate expression (HR/PR). The statistical value calculating unit 13 supplies the calculated statistical value to the analyzing unit 15.

The storage unit 14 stores definition information that defines a sign of a disease by the relationships between the first parameter and the second parameter. Preferably, the storage unit 14 is a secondary storage device (e.g., a hard disk drive) in the disease predicting apparatus 1. Alternatively, the storage unit 14 may be a stand-alone device (e.g., a USB (Universal Serial Bus) memory) which is detachable from the disease predicting apparatus 1.

For example, the definition information stored in the storage unit 14 defines the tendency of a temporal change of the statistical value which is calculated from the first parameter and the second parameter, and the risk of an occurrence of a disease. A specific example of the information will be described later together with the process of the analyzing unit 15.

The analyzing unit 15 analyzes a sign of a disease of the subject based on the definition information stored in the storage unit 14, and the statistical value (the correlation coefficient, the standard deviation, and the slope of the approximate expression) calculated by the statistical value calculating unit 13. In other words, the analyzing unit 15 predicts a situation which is not facially abnormal, but in which there is a future risk of a disease (e.g., a heart disease). The analysis process will be described in detail later by using a specific data example.

The output unit 16 notifies the user (a doctor, a nurse, the subject, or the like) that there is a sign of a disease, by sound or display. The output unit 16 is configured by a liquid crystal monitor and speaker of a usual biological information monitor, their peripheral circuits, and the like. The output unit 16 may perform an output operation of in cooperation with a communication function of the disease predicting apparatus 1, transmitting the detection of a sign of a disease to another terminal device (e.g., a portable terminal device of the nurse in attendance).

Then, a specific example of the analysis process performed by the analyzing unit 15 will be described.

### Example of Analysis by Analyzing Unit 15 (Prediction of Heart Disease)

Firstly, an example of the definition information stored in the storage unit 14 will be described with reference to FIGS. 3A and 3B. FIG. 3A shows definition information defining relationships between the first and second parameters in the case where the first parameter is the heart rate (HR), and the second parameter is the pulse rate (PR). The heart rate (HR) is the number of beats of the heart (heartbeat number per minute) which is calculated based on the QRS wave of the ECG. The pulse rate (PR) is a numerical value per minute which is obtained by counting changes of the pulsation of the artery by a probe attached to a peripheral portion (e.g., a fingertip). The both parameters have values caused by the pulsation of the heart. Therefore, the heart rate (HR) and pulse rate (PR) which are calculated from the same subject are equal to each other in principle. However, the values are sometimes different from each other because of various reasons.

In other words, ideally, the correlation coefficient which is calculated from the heart rate (HR) and the pulse rate (PR) is infinitely close to 1. Ideally, the standard deviations which are calculated from the heart rate (HR) and the pulse rate (PR) are infinitely small because the dispersion is small. In the case where the correlation coefficient is decreased and the standard deviation (SD) of the pulse rate (PR) is larger than a value which is obtained by multiplying the average value (hereinafter, often referred to as PRave) of the pulse rate (PR) with 0.1 (10%) (|SD|>=0.1*PRave), it is supposed that the value of the pulse rate (PR) which is often measured at the fingertip is varied by body motion noise ((C) of FIG. 3A). Therefore, it is defined that this case is not determined to show a sign of a disease. Although only definitions relating to body motion noise are indicated in the case of FIG. 3A, definitions are not limited to them. It is a matter of course that definitions may be employed in which noises due to a contact failure of a probe for the SpO2, external light, and the like are considered. Hereinafter, cases ((A) and (B) of FIG. 3A) other than the case where noises are used will be considered.

In the case where the value of the correlation coefficient is decreased, it is supposed that the difference between the two parameters is made larger from any cause. In this case, when the slope of an approximate expression obtained by using the latest data of the parameters and predetermined numbers of data preceding the latest data (e.g., the slope of a linear expression calculated by the least-squares method, and, in the following description, referred to as “slope of the approximate linear expression (HR/PR)”) becomes larger, it is supposed that, during counting of one pulsation, the heart is driven at an abnormally high speed, and a plurality of heartbeats are counted. Namely, a risk of a heart abnormality such as tachycardia is supposed ((A) of FIG. 3A). It is possible also to suppose that the pulsation is very slow with respect to one heartbeat. Also from this viewpoint, there is suspicion of a heart abnormality such as a circulatory failure of the cardiopulmonary function ((A) of FIG. 3A).

By contrast, the case where, when the value of the correlation coefficient of the heart rate (HR) and the pulse rate (PR) is decreased, the slope of the approximate linear expression (HR/PR) becomes larger will be considered. In this case, it is supposed that, with respect to one pulse, there is a pulsation which is not counted as the heart rate. Therefore, this means that there is suspicion of arrhythmia ((B) of FIG. 3A).

The definition information (FIG. 3A) defines relationships between the manner in which the statistical value is changed, and a risk of a disease, by the relationships between the first and second parameters. In other words, the definition information defines relationships between a temporal change of the statistical value (the correlation coefficient, the standard deviation, and the slope of the approximate linear expression (HR/PR)) which is calculated from the first and second parameters, and a sign of a disease.

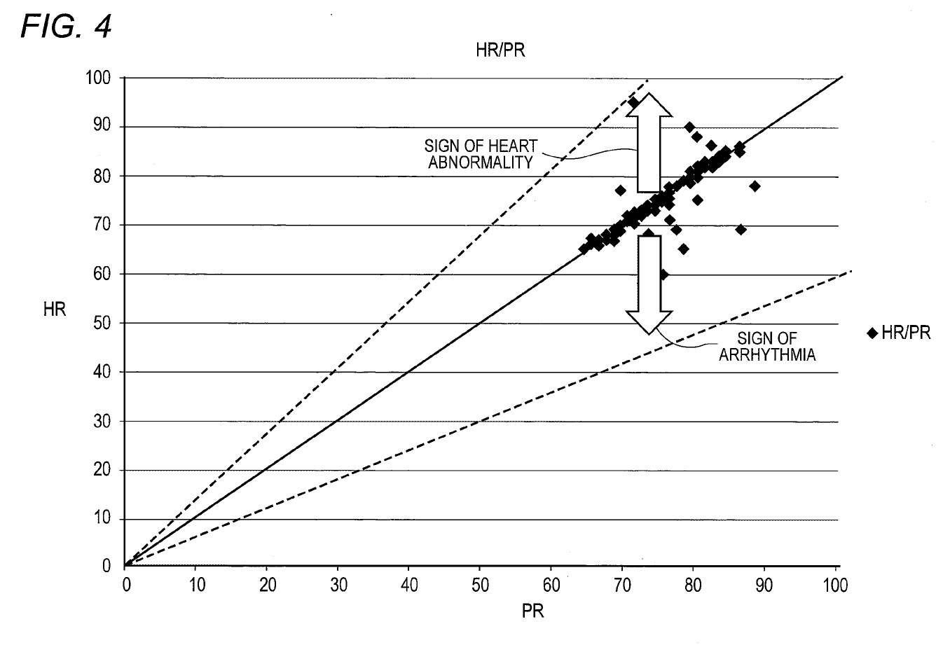

FIG. 4 is a conceptual diagram showing relationships between a change of the slope of the linear expression (HR/PR) which is obtained from the heart rate (HR) and the pulse rate (PR), and a sign of a disease. When the heart rate (HR) and the pulse rate (PR) are not affected by noises or the like, and there is no abnormality in the condition of the body, the heart rate (HR) and the pulse rate (PR) are substantially equal to each other. By contrast, an increase of the slope of the approximate linear expression (HR/PR) can be considered to be a sign of a heart abnormality, as described above, and a decrease of the slope of the approximate linear expression (HR/PR) can be considered to be a sign of arrhythmia, as described above.

The analyzing unit 15 predicts a sign of a disease based on the definition information (FIG. 3A). As premises, the statistical value calculating unit 13 sequentially calculates the correlation coefficient of the heart rate (HR) and the pulse rate (PR), the standard deviations, and the slope of the approximate linear expression (HR/PR). The analyzing unit 15 accumulates data of the heart rate (HR) and the pulse rate (PR), and performs analysis by using the accumulated data.

The process of calculating a statistical value in the statistical value calculating unit 13 will be described in detail. The statistical value calculating unit 13 calculates the correlation coefficient of the heart rate (HR) and the pulse rate (PR) by using a usual expression for calculating a correlation coefficient.

The statistical value calculating unit 13 further calculates the standard deviation of the pulse rate (PR) in accordance with a usual formula for calculating the standard deviation.

The statistical value calculating unit 13 further calculates the slope of a linear expression which is calculated from the heart rate (HR) and the pulse rate (PR) by using the least-squares method or the like. For example, the statistical value calculating unit 13 extracts ten data from the latest data in FIG. 2, performs the least-squares method on the ten data, and calculates the slope of the approximate linear expression (HR/PR).

As described above, the statistical value calculating unit 13 preferably calculates the statistical value (the correlation coefficient, the standard deviation, and the slope of the approximate linear expression (HR/PR)) by using a predetermined number or more of data preceding the latest data. In the case where the slope of the approximate linear expression (HR/PR) or the like is obtained by using only the latest data and the previous one data, for example, the calculation is largely affected by body motion and the like, and there is a possibility that an erroneous value may be calculated. When a predetermined number or more of data are used, however, the influence of outliers can be made small in the statistical value calculating unit 13, and therefore the statistical value can be accurately calculated.

The analyzing unit 15 refers the definition information (FIG. 3A), and compares a temporal change of the statistical value which is calculated by the statistical value calculating unit 13, with the definition information (FIG. 3A), thereby analyzing a sign of a disease. In the case where the correlation coefficient is decreased, the standard deviation of the pulse rate (PR) is smaller than 10% of the mean pulse rate (PR), and the slope of the approximate linear expression (HR/PR) is increased, for example, the analyzing unit 15 analyzes that there is a risk of a heart abnormality.

When matching with the definition information occurs, the analyzing unit 15 may not immediately determine that there is a sign of a disease, but instead may determine that the subject has a sign of a disease after the matching with the definition information continues over a predetermined period of time. Therefore, the analyzing unit 15 can adequately cancel a case such as that where measurement values are temporarily changed by an influence of noises or the like, and it is possible to realize a more accurate analysis of a sign of a disease.

In the above-described process, all of the correlation coefficient, the standard deviations, and the slope of the approximate linear expression (HR/PR) are used as the statistical value. The process is not limited to this. For example, the analyzing unit 15 may perform an analysis process while only the correlation coefficient and the standard deviations are obtained, and an approximate expression is not used.

It is usual that the heart rate (HR) and the pulse rate (PR) have the same value. When the slope of the approximate linear expression (HR/PR) is changed, it is seen that there is any kind of abnormality. Based on the direction of the change of the slope of the approximate linear expression (HR/PR), the analyzing unit 15 can identify the kind of the occurring abnormality. When any kind of physical abnormality occurs, deviation begins to be caused between the heart rate (HR) and the pulse rate (PR), and therefore it is supposed that the value of the correlation coefficient is decreased. When the determination is performed in consideration of also the values of the standard deviations and the correlation coefficient, therefore, the analyzing unit 15 can predict a sign of a disease (mainly, a heart disease) more accurately. The analysis may be performed by using only the correlation coefficient and the standard deviations and without using the slope of the approximate linear expression (HR/PR), because of the following reason. As described above, ideally, the heart rate (HR) and the pulse rate (PR) have the same value. When the deviation between the two parameters becomes large, it is possible to analyze that any kind of abnormality occurs, although the cause of this phenomenon is unknown.

### Example of Analysis by Analyzing Unit 15 (Prediction Using Heart Rate and Respiration)

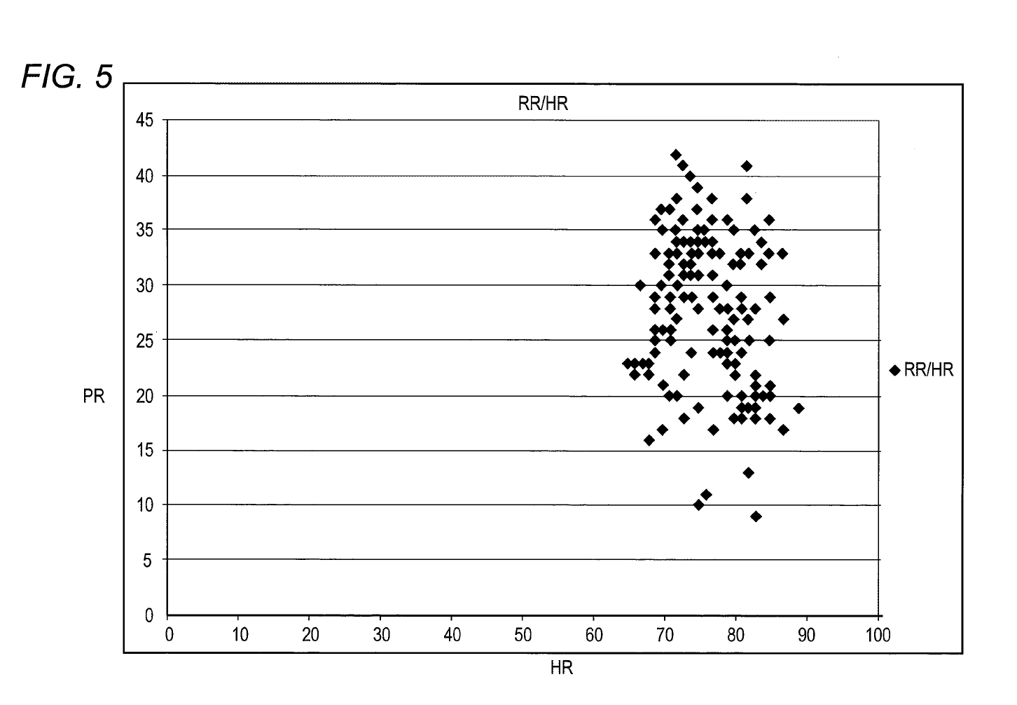

In FIG. 3A, the definition information which is used for predicting a disease based on the relationships between the heart rate (HR) and the pulse rate (PR) is employed. A similar analysis may be performed by using other biological parameters. FIG. 3B shows definition information defining relationships among the heart rate (HR), the respiration rate (RR), and the occurrence of a disease. FIG. 5 is a view in which relationships between the heart rate (HR) and respiration rate (RR) of a certain subject are plotted. As shown in FIG. 5, usually, the heart rate (HR) and the respiration rate (RR) are slightly correlated with each other. In other words, the two parameters are remotely related with each other.

In the case where the correlation coefficient is increased (the value is changed in the direction of correlation), and the slope of an approximate linear expression (RR/HR) is increased, however, this phenomenon means that respirations are detected in an abnormally large number during measurement of one heartbeat. In this case, namely, there is a risk of hyperventilation or the like ((A) of FIG. 3B). In the case where such a situation is detected during execution of rehabilitation, therefore, there is a risk of overexercise, and a countermeasure such as that instructions for stopping the exercise are audibly output, or that the rehabilitation program is revised should be taken.

In the case where the correlation coefficient is increased (the value is changed in the direction of correlation), and the slope of an approximate linear expression (RR/HR) is decreased, by contrast, this phenomenon means that heartbeats are detected in an abnormally large number during measurement of one respiration. In this case, there is a possibility that double counting of the heart rate or the like may occur, namely, arrhythmia such as motor bundle branch block or the like may be caused. In the case where such a situation is detected during, for example, execution of rehabilitation, therefore, there is a sign of arrhythmia, and hence a countermeasure such as that instructions for stopping the exercise are audibly output, or that the rehabilitation program is revised should be taken.

The analyzing unit 15 analyzes a sign of a disease by comparing the definition information (FIG. 3B) with the statistical value calculated by the statistical value calculating unit 13. In the case where the correlation coefficient is increased, and the slope of the approximate linear expression (RR/HR) is increased, for example, the analyzing unit 15 analyzes that there is a risk of overexercise. Also in this example, the analyzing unit 15 may simply analyze a sign of a disease by using only the slope of the approximate linear expression (RR/HR).

The specific example of the analysis process performed by the analyzing unit 15 has been described. The definition information is not limited to that shown in FIGS. 3A and 3B, and of course definition may be performed by using other biological parameters. After the disease predicting apparatus 1 begins to be used, the user can define new definition information by using an input unit (mouse, keyboard, or the like) which is not shown.

Next, effects of the disease predicting apparatus 1 according to the exemplary embodiment will be described. The definition information defines a sign of a disease by the relationships between the biological parameters. The analyzing unit 15 performs analysis by using a change of the statistical value calculated from the first and second parameters. A change of the statistical value is an effective index indicating a change of the biological condition of the subject. The analyzing unit 15 compares the change of the statistical value with the definition information, whereby a possibility of a future occurrence of a disease in the subject can be predicted. Since a possibility of an occurrence of a disease can be predicted, it is possible to, even before biological parameters reach respective abnormal values (e.g., an ECG is in the VF state), perform notification or the like by an alarm output.

More specifically, the analyzing unit 15 analyzes a sign of a disease in accordance with a change of the slope of an approximate expression of the first and second parameters (FIG. 3A, etc.). The process of calculating the slope of an approximate expression is a process which requires a small calculation amount, and which can be easily incorporated in the disease predicting apparatus 1 even in the case where the apparatus is a biological information monitor or the like.

Moreover, the analyzing unit 15 analyzes a sign of a disease in consideration of also changes of the correlation coefficient and standard deviations of the first and second parameters. A correlation coefficient indicates the correlation between parameters, and a standard deviation defines the dispersion of data. The analyzing unit 15 handles changes of the correlation coefficient and the standard deviations, and therefore can objectively detect a change of the biological condition.

While the present invention has been described with reference to a certain exemplary embodiment thereof, the scope of the present invention is not limited to the exemplary embodiment described above, and it will be understood by those skilled in the art that various changes and modifications may be made therein without departing from the scope of the present invention as defined by the appended claims.

In the above, the example in which the first and second parameters are biological parameters acquired from the body of the subject has been described. The invention is not limited to this. For example, one of the first and second parameters may be an environmental factor (the temperature, the humidity, the illuminance, or noises), attribute information (the sex, the age, or the residence), or the like. Also in this case, by defining the relationships between the first and second parameters as definition information from medical viewpoint, it is possible to analyze a sign of a disease.

The processes in the statistical value calculating unit 13 and the analyzing unit 15 may be implemented as computer programs which operate in the disease predicting apparatus 1. Namely, the disease predicting apparatus 1 includes also a configuration which has a general computer, such as a central processing unit (CPU), a hard disk drive, and a cache memory.

The programs may be stored in a non-transitory computer readable medium of any one of various types, and then supplied to the computer. The non-transitory computer readable medium includes tangible storage media of various types. Examples of the non-transitory computer readable medium are a magnetic recording medium (e.g., a flexible disk, a magnetic tape, and a hard disk drive), a magneto-optical recording medium (e.g., a magneto-optical disk), a CD-read only memory (CD-ROM), a CD-R, a CD-R/W, a semiconductor memory (e.g., a mask ROM, a programmable ROM (PROM), an erasable PROM (EPROM), a flash ROM, and a random access memory (RAM)). Alternatively, the programs may be supplied to the computer by means of a transitory computer readable medium of any one of various types. Examples of the transitory computer readable medium are an electrical signal, an optical signal, and an electromagnetic wave. The transitory computer readable medium can supply the programs to the computer through a wired communication path such as a metal wire or an optical fiber, or a wireless communication path.

What is claimed is:

1. A disease predicting apparatus including:
a first parameter acquiring unit configured to acquire a first parameter indicating a biological condition of a subject;
a second parameter acquiring unit configured to acquire a second parameter indicating another biological condition of the subject;
a statistical value calculating unit configured to calculate a statistical value indicating relationships between the first parameter and the second parameter;
a storage unit storing definition information that defines a sign of a disease by the relationships between the first parameter and the second parameter; and
an analyzing unit configured to analyze a sign of a disease of the subject based on a temporal change of the statistical value and the definition information.

2. The disease predicting apparatus according to claim 1, wherein the statistical value includes a slope of an approximate expression obtained from a coordinate system on which a value of the first parameter and a value of second parameter at each point of time are plotted.

3. The disease predicting apparatus according to claim 2, wherein the definition information defines relationships between a temporal change of the slope of the approximate expression and a sign of a disease, and
wherein the analyzing unit is configured to compare the temporal change of the slope of the approximate expression calculated by the statistical value calculating unit, with the definition information, to analyze the sign of the disease of the subject.

4. The disease predicting apparatus according to claim 3, wherein the definition information defines, in addition to the slope of the approximate expression, relationships between a temporal change of a correlation coefficient of the first parameter and the second parameter and a disease, and
wherein the analyzing unit compares the temporal change of the slope of the approximate expression and the correlation coefficient that are calculated by the statistical value calculating unit, with the definition information, to analyze the sign of the disease of the subject.

5. The disease predicting apparatus according to claim 3, wherein the definition information defines, in addition to the slope of the approximate expression, relationships between a temporal change of a standard deviation of the first parameter and the second parameter and a disease, and
wherein the analyzing unit is configured to compare the temporal change of the slope of the approximate expression and the standard deviations that are calculated by the statistical value calculating unit, with the definition information, to analyze the sign of the disease of the subject.

6. The disease predicting apparatus according to claim 1, wherein the statistical value calculating unit is configured to extract a predetermined number or more of data in order from latest data of the first parameter and the second parameter and to calculate the statistical value by using the extracted data.

7. The disease predicting apparatus according to claim 1, wherein the analyzing unit is configured to determine that there is a sign of a disease in the subject in a case where a predetermined period of time elapses after a change of the statistical value matches a state defined by the definition information.

8. The disease predicting apparatus according to claim 1, wherein the first parameter is a heart rate HR and the second parameter is a pulse rate PR, and
wherein the analyzing unit is configured to determine that there is a risk of a heart abnormality in the subject in a case where a slope of an approximate linear expression HR/PR is increased, and that there is a risk of arrhythmia in the subject in a case where the slope of the approximate linear expression HR/PR is decreased.

9. A disease predicting method comprising:
acquiring a first parameter indicating a biological condition of a subject;
acquiring a second parameter indicating another biological condition of the subject;
calculating a statistical value indicating relationships between the first parameter and the second parameter; and
analyzing a sign of a disease of the subject based on temporal change of the statistical value and definition information that defines the sign of the disease by the relationships between the first parameter and the second parameter.

10. A non-transitory computer readable medium storing a program that, when executed by a computer, causes the computer to execute a method comprising:
calculating a statistical value indicating relationships between a first parameter indicating a biological condition of a subject and a second parameter indicating another biological condition of the subject; and
analyzing a sign of a disease of the subject based on a temporal change of the statistical value and definition information that defines the sign of the disease by relationships between the first parameter and the second parameter.

11. A disease predicting apparatus comprising:
a first parameter acquiring unit configured to acquire a first parameter indicating a biological condition of a subject;
a second parameter acquiring unit configured to acquire a second parameter relating to a factor of an environment surrounding the subject or an attribute of the subject;
a statistical value calculating unit configured to calculate a statistical value indicating relationships between the first parameter and the second parameter;
a storage unit storing definition information that defines a sign of a disease by the relationships between the first parameter and the second parameter; and
an analyzing unit configured to analyze a sign of a disease of the subject based on a temporal change of the statistical value and the definition information.
